(19) United States
(12) Patent Application Publication
(10) Pub. No.: US 2023/0104844 A1
(43) Pub. Date: Apr. 6, 2023

(54) Measurement Device

(71) Applicant: Nippon Telegraph and Telephone Corporation, Tokyo (JP)

(72) Inventors: Yujiro Tanaka, Tokyo (JP); Daichi Matsunaga, Tokyo (JP)

(21) Appl. No.: 17/913,576

(22) PCT Filed: Apr. 1, 2020
(86) PCT No.: PCT/JP2020/015028

§ 371 Date: Sep. 22, 2022

(51) Int. Cl. G01K 1/143; G01K 13/20; G01K 17/00

(52) U.S. Cl. CPC G01K 1/143; G01K 13/20; G01K 17/00

(57) ABSTRACT

A measurement device includes: a sensor including a temperature sensor configured to measure a temperature of a surface of a skin of a living body which is a measurement surface; a first cover having a hollow structure and covering the sensor; and a second cover having a hollow structure and covering the first cover to form an air layer between the first cover and the second cover.

### CROSS-REFERENCE TO RELATED APPLICATIONS

This application is a National phase entry of PCT Application No. PCT/JP2010/015028, filed on Apr. 1, 2020, which application is hereby incorporated herein by reference.

### TECHNICAL FIELD

Embodiments of the present invention relate to a measurement device for measuring a core body temperature of a living body.

### BACKGROUND

There has been known a technique for noninvasively measuring the core body temperature of a living body. For example, Patent Literature 1 discloses a technique for estimating the core body temperature of a living body by assuming a pseudo one-dimensional model including a living body, a sensor including a temperature sensor and a heat flux sensor, and outside air.

In the technique disclosed in Patent Literature 1, the core body temperature of a living body is estimated by using the following relational expression (1) based on a one-dimensional model of heat transfer of a living body.

core body temperature Tc=the temperature (Ts) of the point of contact between the temperature sensor and the skin+proportionality coefficient(α)×the heat(Hs) that flows into the temperature sensor (1)

The proportionality coefficient α is in general obtained by using a rectal temperature or an eardrum temperature measured with a sensor such as another temperature sensor, as the core body temperature Tc.

However, for example, in the case of assuming a one-dimensional model as a heat transfer model of a living body as in the conventional technique described in Patent Literature 1, if heat flows from the outside air into the sensor due to an occurrence of air flow or the like, the heat resistance between the sensor and the outside air changes, and the foregoing one-dimensional model no longer holds. Thus, there is a problem in conventional techniques for measuring core body temperatures in that when air flow comes in contact with the sensor, it causes errors in measurement of the core body temperature.

### CITATION LIST

### Patent Literature

Patent Literature 1: Japanese Patent Laid-Open No. 2020-003291.

### SUMMARY

### Technical Problem

Embodiments of the present invention have been made to solve the foregoing problem, and an object thereof is to provide a measurement device capable of reducing change in the heat resistance between the sensor and the outside air even if air flow comes in contact with the sensor.

### Means for Solving the Problem

To solve the foregoing problem, a measurement device according to embodiments of the present invention includes: a measurement unit including a first temperature sensor configured to measure a temperature of a measurement surface; a first cover having a hollow structure and covering the measurement unit; and a second cover having a hollow structure and covering the first cover to form an air layer between the first cover and the second cover.

### Effects of Embodiments of the Invention

Since the measurement device according to embodiments of the present invention includes the first cover having the hollow structure and covering the measurement unit and the second cover having the hollow structure and covering the first cover to form the air layer between the first cover and the second cover, even if air flow comes in contact with the sensor, it is possible to reduce change in the heat resistance between the sensor and the outside air.

### BRIEF DESCRIPTION OF THE DRAWINGS

FIG. 1 is a schematic diagram of a cross section of a measurement device according to a first embodiment of the present invention.

FIG. 2 is a diagram for explaining an overview of the present invention.

FIG. 3 is a block diagram illustrating an example of the configuration of the measurement device according to the first embodiment.

FIG. 4 is a schematic diagram of a cross section of a measurement device according to a second embodiment.

FIG. 5 is a block diagram illustrating an example of the configuration of the measurement device according to the second embodiment.

FIG. 6 is a diagram for explaining an advantageous effect of the measurement device according to the second embodiment.

### DETAILED DESCRIPTION OF ILLUSTRATIVE EMBODIMENTS

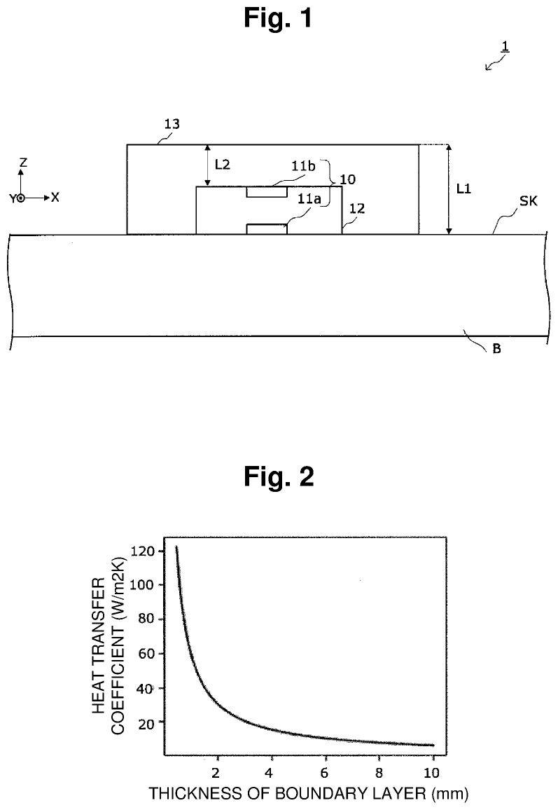

Hereinafter, preferred embodiments of the present invention will be described in detail with reference to FIGS. 1 to 6. Note that the following describes a case in which the “measurement surface” on which a measurement device is placed is the surface of a skin of a living body which is a measurement target.

### Overview of Embodiments of the Invention

First, an overview of a measurement device according to embodiments of the present invention will be described with reference to FIG. 2. In the case in which a stationary object is placed in fluid having a uniform flow speed V, the flux decreases toward the surface of the object due to the influence of the viscosity of the fluid, and the flux becomes zero at the surface of the object. The distance from the surface of the object where the flow speed V=0 to where the flow speed is a uniform speed V is called a boundary layer. The thickness of the boundary layer varies according to the Reynolds number Re. Although it depends on the shape or the like, for example, in the case of a flat surface, defining the distance from an end face of a surface as x, the thickness δ of the boundary layer is expressed by the following expression (2).

δ˜5×/√Re (2)

Here, the Reynolds number Re is expressed by the following expression (3).

Re=pVL/μ (3)

In the above expression (3), p represents the density of air, L the distance from the end face of the flat plate, μ the viscosity of air, and V the flow speed.

Specifically, the boundary layer grows according to the distance from the end face of the flat plate, which is the characteristic length. Now, think about the flow of heat. Heat is mainly transported by heat conduction in which heat is transferred by the temperature gradient according to Fourier's law and convective heat transfer in which heat is transferred by the flow of fluid. As mentioned earlier, a boundary layer is generated on the surface of an object. Assuming that fluid is almost stationary within the thickness of the boundary layer, heat conduction is the main factor of transportation of heat within the boundary layer.

However, in the case in which the boundary layer is small, convective heat transfer is the main factor. The heat transfer coefficient h representing the degree of convective heat transfer is expressed by the Nusselt number Nu and the Prandtl number Pr which are dimensionless numbers obtained by making characteristic values and physical property values related to the flow of fluid and heat dimensionless. It is known that on a plane, the heat transfer coefficient h can be obtained as below.

$$Nu = h \cdot L / λ \qquad ( 4 )$$

$$Nu = 0.664 {Re}^{1 / 2} {Pr}^{1 / 3} ( laminar flow ) \qquad ( 5 )$$

$$= 0.037 {Re}^{4 / 5} {Pr}^{1 / 3} ( turbulent flow ) \qquad {( 5 )}^{′}$$

$$h = λ / L \cdot Nu = 0.664 ( λ / L ) {Re}^{1 / 2} {Pr}^{1 / 3} \qquad ( 6 )$$

$$Pr = VC / λ \qquad ( 7 )$$

In the above expressions (4) to (7), L represents the distance from the end face of the flat plate, λ the thermal conductivity of air, μ the viscosity of air, C the thermal capacity of air, and V the flow speed.

In the case in which the boundary layer is thin, and convective heat transfer is dominant, the heat transportation varies depending on the speed of fluid. Here, think about the flow of heat around a sensor placed on a measurement surface. Assuming a state of laminar flow which is the smooth flow of fluid (air in this case), the Reynolds number Re is approximately 3000. In this case, parts of a living body such as the arms and the head are approximately ten and several centimeters. Using this as the characteristic length, the boundary layer is probably approximately 10 [mm]. In the case of a boundary layer having a thickness of approximately several millimeters, it can be said that heat conduction is dominant. In the case of a sensor having a size of 20 [mm], the thickness of the boundary layer is approximately 1 [mm], or smaller than or equal to 1 [mm].

In the case in which the shape of a sensor has sharp changes, the apparent thickness of the boundary layer is probably smaller. In summary, in the case in which there is an air flow, heat conduction is dominant on the surface of the living body, but near the sensor, convective heat transfer is dominant. Seemingly, different heat resistances are seen, and thus, use of a one-dimensional heat transfer model of a living body according to the foregoing expression (i) causes an error in the estimation value of the core body temperature.

Hence, it is desirable that the boundary layer be sufficiently developed around the sensor, but in practice, it is difficult to develop the boundary layer around the sensor. Thus, in the present embodiment, a boundary layer is formed around the sensor by structurally forming such an air layer that covers the sensor.

An index that indicates how heat transmits from a living body through a sensor to the outside air is the Biot number Bi shown in the following expression (8).

Bi=hL/λ (8)

Here, h represents the heat transfer coefficient, L the depth to the core body temperature, and λ the thermal conductivity of the living body.

In order that the foregoing pseudo one-dimensional heat transfer model of a living body holds, the Biot number Bi needs to be approximately 0.1 or less. Since it is impossible to control the thermal conductivity of a living body and the depth to the core temperature, it is necessary to control the thickness of the foregoing air layer to reduce the heat transfer coefficient. In the case in which the Biot number Bi is approximately 0.1 or less, as specific values of heat transfer coefficients h of main materials included in a living body, the heat transfer coefficient of water is h<6 [W/m²K], the heat transfer coefficient of muscle h<4 [W/m²K], and the heat transfer coefficient of fat h<1.8 [W/m²K].

As also can be seen from the foregoing expression (6), the heat transfer coefficient h is dependent on the thickness of the boundary layer. Here, assuming that x is the distance from the end face of the sensor, the thickness δ of the boundary layer is δ ˜5×/Re^{0.5}. The relationship between the thickness of the boundary layer and the heat transfer coefficient is shown in FIG. 2. The heat transfer coefficient h decreases sharply in the range in which the thickness of the boundary layer is approximately 0 [mm] to 2 [mm], and decreases gently in the range in which the thickness of the boundary layer is approximately 2 [mm] to approximately 10 [mm]. For example, the thickness of the boundary layer with which the heat transfer coefficient h is approximately 10 [W/m²K] is approximately 6 [mm].

However, if the volume of the air layer covering the sensor is large, convection occurs inside the air layer, increasing the heat transfer coefficient. In this case, the Nusselt number Nu of the inside of the air layer is expressed by the following expression (9).

Nu=0.46(PrGr)^{1/4}A^{0.3}Pr^{0.012} (9)

In the above expression (9), A represents the aspect ratio of the air layer, and Gr the Grashof number, which is expressed by the following expression (10).

$$\begin{matrix}Math 1 & \\ G r = \frac{{L}^{3} g β Δ θ}{v} & ( 10 )\end{matrix}$$

In the above expression (10), L represents the characteristic length, g the body force, β the thermal expansion, v the kinematic viscosity, Cp the thermal capacity, μ the viscosity, λ the thermal conductivity, Δθ the temperature difference, and h the heat transfer coefficient.

As above, the measurement device according to the present embodiment, which has a structure that partitions the air layer around the sensor, forms an air layer, in other words, the thickness of the boundary layer so that the Biot number Bi is approximately 0.1 or less, and that the air around the sensor cannot move.

### First Embodiment

Next, a measurement device 1 according to a first embodiment of the present invention will be described with reference to FIGS. 1 to 9B. Note that in each figure in the following description, the right-left or horizontal direction on the drawing plane is the X direction, the up-down direction or the vertical direction on the drawing plane is the Z direction, and the direction perpendicular to the drawing plane is the Y direction.

First, a principal part of the measurement device 1 will be described. FIG. 1 is a diagram schematically illustrating a partial cross section of the measurement device 1 placed to be in contact with a skin SK of a living body B. The measurement device 1 includes a sensor (measurement unit) 10, a first cover 12, and a second cover 13.

The sensor 10 includes two temperature sensors 11a and 11b.

The temperature sensor (first temperature sensor) 11a is placed to be in contact with the surface of the skin SK of the living body B which is the measurement surface. The temperature sensor 11a measures the temperature T2 which is the temperature of the point of contact with the living body B (the temperature of the measurement surface).

The temperature sensor (second temperature sensor) 11b is placed on an inner surface of the first cover 12 and measures the temperature T1 at the place where the temperature sensor 11b is placed. For example, as illustrated in FIG. 1, the temperature sensors 11a and 11b are placed in the internal space of the first cover 12 so as to face each other. For example, the temperature sensors 11a and 11b are placed on inner surfaces of the first cover 12 to face each other along the Z direction.

For the temperature sensors 11a and 11b, for example, thermistors, thermocouples, platinum resistors, IC temperature sensors, or the like can be used. The temperature sensors 11a and 11b, for example, have a size of 4 [mm] along the X direction and 4 [mm] along the Y direction.

The first cover 12 has a hollow structure and is placed on the measurement surface so as to cover the sensor 10 including the temperature sensors 11a and 11b. The first cover 12 is formed of thin film and, for example, can have a hollow structure having a cylindrical outer shape. The inside of the first cover 12 is filled with air.

For example, the temperature sensor 11a is placed on the inner surface of the bottom face at which the cylindrical first cover 12 is configured to be in contact with the measurement surface, and the temperature sensor 11b is placed on the inner surface of the upper face so as to face the temperature sensor 11a.

For the first cover 12, for example, thin film having a thickness of approximately 0.1 [mm], for example, a PET sheet or the like can be used. The diameter of the cylindrical shape of the first cover 12 (the length in the X direction) can be, for example, 20 [mm].

The second cover 13 has a hollow structure, is placed on the measurement surface so as to cover the first cover 12, and forms an air layer between the first cover 12 and the second cover 13. As illustrated in FIG. 1, the height L1 of the second cover 13 along the Z direction from the measurement surface as a reference, in other words, the height of the boundary layer formed by the second cover 13 is set so as to satisfy a specified condition. The specified condition means a height with which the thickness of the boundary layer formed by the second cover 13 satisfies the condition that the Biot number Bi indicating the stability of heat transfer from the measurement surface is 0.1 or less. For example, the height L1 can be approximately 6 [mm].

The distance L2 (the height difference) from the height of the first cover 12 from the measurement surface as a reference, in other words, the temperature sensor 11b, to the height of the second cover 13 needs to be a distance L2 that makes heat conduction dominant in this region. For example, the distance (thickness) L2 of the air layer between the first cover 12 and the second cover 13 along the Z direction illustrated in FIG. 1 can be several millimeters or so, such as 3 [mm], for example, which is smaller than the height L1.

The second cover 13 is formed of thin film like the first cover 12 and has a hollow structure having a cylindrical outer shape, the inside of which is filled with air. For the second cover 13, for example, thin film having a thickness of approximately 0.1 [mm], for example, a PET sheet or the like can be used. The diameter of the cylindrical shape of the first cover 12 (the length in the X direction) can be, for example, 30 [mm].

As described above, an air layer is formed by the first cover 12, and an air layer is formed between the first cover 12 and the second cover 13 outside the first cover 12. Thus, there are provided small rooms for air partitioned so that the air inside each of the first cover 12 and the second cover 13 does not move.

[Configuration of Measurement Device]

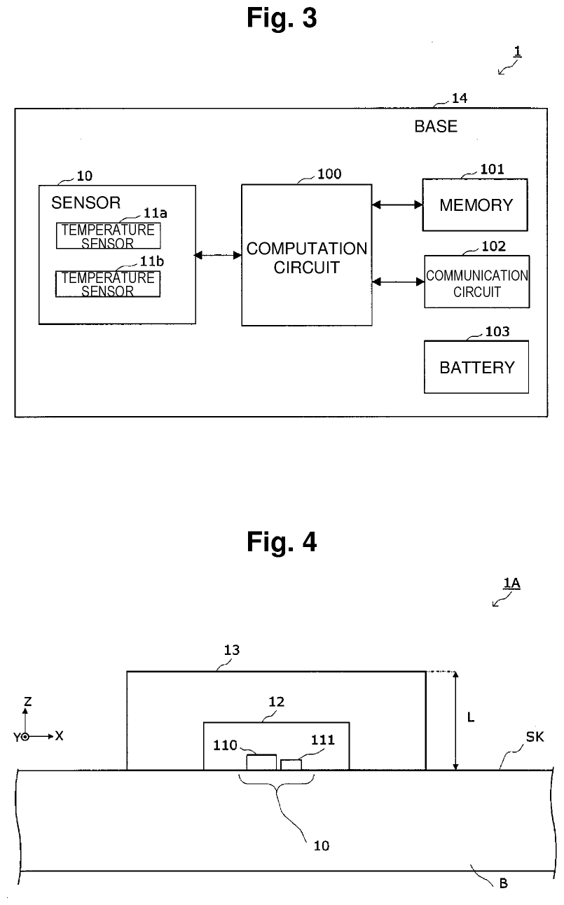

Next, the overall configuration of the measurement device 1 according to the present embodiment will be described with reference to FIG. 3.

As illustrated in FIG. 3, the measurement device 1 includes the principal part of the measurement device 1 described with reference to FIG. 1, a computation circuit 100, a memory tot, a communication circuit 102, and a battery 103. Note that in FIG. 3, illustration of the first cover 12 and the second cover 13 is omitted.

The measurement device 1, for example, includes, on a sheet-shaped base 14, the sensor to, the computation circuit 100, the memory tot, the communication circuit 102 that functions as a circuit of an I/F with the outside, and the battery 103 that supplies electric power to the computation circuit 100, the communication circuit 102, and the like.

The computation circuit 100 calculates an estimation value of the core body temperature Tc from the temperatures T1 and T2 measured by the temperature sensors 11a and 11b included in the sensor 10 by using the following expression (11).

core temperature Tc=T1+α×(T2−T1) (11)

Here, a represents a proportionality coefficient, which is a value obtained in advance by using the temperature of an eardrum, the rectal, or the like.

The computation circuit 100 may generate and output time series data of estimated core body temperatures Tc of the living body B. The time series data means data including measurement time and estimated core body temperatures Tc associated with each other.

The memory 101 stores information on a one-dimensional heat transfer model of a living body based on the foregoing expression (ii). The memory 101 can be a specified storage area of a rewritable nonvolatile storage device (for example, a flash memory or the like) provided in the measurement system.

The communication circuit 102 outputs time series data of the core body temperature Tc of the living body B generated by the computation circuit 100, to the outside. In the case of outputting data in a wired way, the communication circuit 102 as above is an output circuit to which a USB cable or other types of cables can be connected, but it may be a wireless communication circuit, for example, conforming to Bluetooth (registered trademark), Bluetooth Low Energy, or the like.

The sheet-shaped base 14 not only functions as a base on which the measurement device 1 is placed including the sensor 10, the computation circuit 100, the memory 101, the communication circuit 102, and the battery 103 but also includes not-illustrated wiring for electrically connecting these elements. Considering that the measurement device 1 is connected to epidermis of a living body, it is desirable that a deformable flexible substrate be used for the sheet-shaped base 14.

Part of the sheet-shaped base 14 has an opening, and the temperature sensor 11a included in the sensor 10 is placed on the base 14 so as to be in contact with the measurement surface of the skin SK of the living body B through the opening.

Here, the measurement device 1 is configured by including a computer. Specifically, the computation circuit 100 is implemented, for example, by a processor such as a CPU or a DSP executing various kinds of data processing according to programs stored in the storage device such as a ROM, a RAM, or a flash memory, including the memory 101 provided in the measurement device 1. The above programs for causing the computer to function as the measurement device 1 can be recorded on a recording medium or can be supplied through a network.

Note that although in the measurement device 1 in FIG. 3, the principal part including the sensor 10 described with reference to FIG. 1 and other constituents including the computation circuit 100 are configured as one unit, the principal part of the measurement device 1 may be separate from the computation circuit 100, the memory 101, the communication circuit 102, and the battery 103. For example, the measurement device 1 and the other constituents such as the computation circuit 100 may be connected via not-illustrated wiring.

As has been described above, in the measurement device 1 according to the first embodiment, the temperature sensors 11a and 11b are placed in the internal space of the first cover 12 having a hollow structure, and in addition, the second cover 13 having a hollow structure is provided outside the first cover 12. The height of the second cover 13 is such that the Biot number Bi is approximately 0.1 or less. Thus, even if air flow comes in contact with the measurement device 1, it is possible to reduce the influence of change in the heat resistance between the sensor 10 and outside air. This makes it possible to reduce the influence of change in convection and measure the core body temperature Tc of the living body B noninvasively.

In the first embodiment, the two small rooms of air layers are formed by the first cover 12 and the second cover 13, and this reduces the movement of air in the air layers between the sensor 10 and the outside air, making the action of the boundary layer more effective.

### Second Embodiment

Next, a second embodiment of the present invention will be described with reference to FIGS. 4 to 6. Note that in the following description, the same constituents as in the foregoing first embodiment are denoted by the same signs, and description thereof is omitted.

The first embodiment described a case in which the sensor 10 has a pair of the temperature sensors 11a and 11b. Unlike the first embodiment, a sensor 10 in the second embodiment has a heat flux sensor 110 and a temperature sensor 111.

FIG. 4 is a schematic diagram of a partial cross section of a measurement device 1A according to the second embodiment. As illustrated in FIG. 4, the measurement device 1A includes the sensor 10, a first cover 12, and a second cover 13. The sensor 10 includes the heat flux sensor 110 and the temperature sensor (first temperature sensor) 111.

The heat flux sensor 110, which detects heat transfer per unit time per unit area, measures the heat flux Hs [W/m²] that flows into the sensor 10 from the living body B. For the heat flux sensor 110, for example, an actuation thermopile of a layered structure type or a planar expansion type or the like can be used. The heat flux sensor 110 is placed to be in contact with the measurement surface.

The temperature sensor 111 is placed to be in contact with the measurement surface and measures the epidermis temperature Ts which is the temperature of the point of contact with the living body B. For the temperature sensor 111, for example, a thermistor, a thermocouple, a platinum resistor, an IC temperature sensor, or the like can be used. The temperature sensor 111 is placed to be adjacent to the heat flux sensor 110 along the measurement surface.

The first cover 12 has a hollow structure and is placed on the measurement surface so as to cover the sensor 10 including the heat flux sensor 110 and the temperature sensor 111. The first cover 12 is formed of thin film and has a hollow structure having a cylindrical outer shape. For example, the heat flux sensor 110 and the temperature sensor 111 are placed on the inner surface of the bottom face of the cylindrical first cover 12 configured to be in contact with the measurement surface.

For the first cover 12, for example, thin film having a thickness of approximately 0.1 [mm], for example, a PET sheet or the like can be used. The diameter of the cylindrical shape of the first cover 12 (the length in the X direction) can be, for example, 20 [mm].

The second cover 13 is provided outside the first cover 12 and covers the first cover 12 via an air layer. In the second cover 13, as illustrated in FIG. 1, the height L along the Z direction, in other words, the height of the boundary layer formed by the second cover 13 can be, for example, approximately 6 [mm] or more. The height difference between the air layers formed by the first cover 12 and the second cover 13 along the Z direction illustrated in FIG. 1 can be, for example, several millimeters or so which is smaller than the height L of the second cover 13.

The second cover 13 is formed of thin film like the first cover 12 and has a hollow structure having a cylindrical outer shape. For the second cover 13, for example, thin film having a thickness of approximately 0.1 [mm], for example, a PET sheet or the like can be used. The diameter of the cylindrical shape of the first cover 12 (the length in the X direction) can be, for example, 30 [mm].

As described above, a small room of the air layer is formed by the first cover 12, and the air layer is formed between and the first cover 12 and the second cover 13 outside the first cover 12. Thus, there are provided small rooms for air partitioned so that the air inside each of the first cover 12 and the second cover 13 does not move.

[Configuration of Measurement Device]

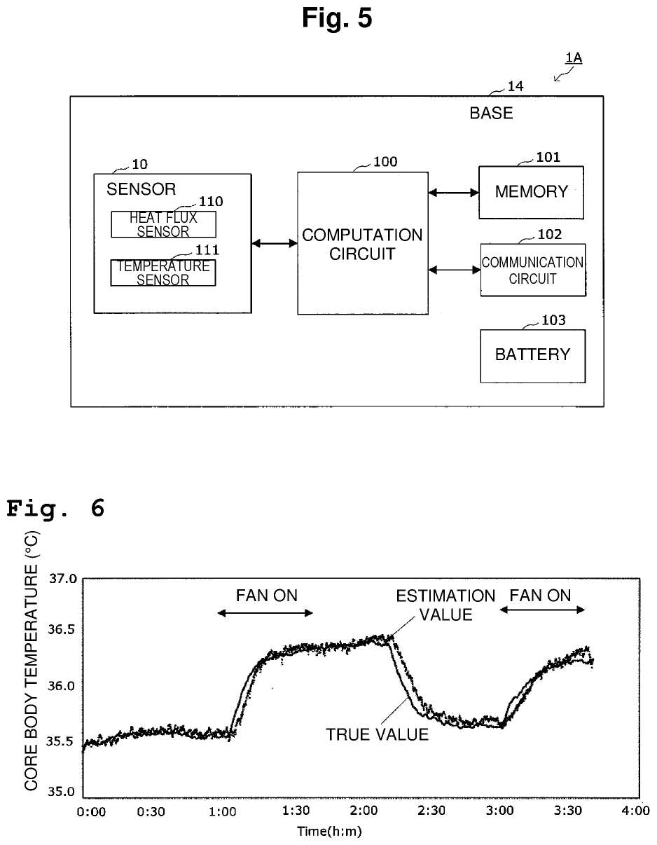

Next, an overall configuration example of the measurement device 1A according to the present embodiment will be described with reference to the block diagram of FIG. 5

As illustrated in FIG. 5, the measurement device 1A includes the principal part of the measurement device 1A described with reference to FIG. 4, a computation circuit 100, a memory tot, a communication circuit 102, and a battery 103. Note that in FIG. 3, illustration of the first cover 12 and the second cover 13 is omitted.

The measurement device 1, for example, includes, on a sheet-shaped base 14, the sensor to, the computation circuit 100, the memory tot, the communication circuit 102 that functions as a circuit of an I/F with the outside, and the battery 103 that supplies electric power to the computation circuit 100, the communication circuit 102, and the like.

The computation circuit 100 calculates an estimation value of the core body temperature Tc from the heat flux Hs measured by the heat flux sensor 110 included in the sensor to and the epidermis temperature Ts measured by the temperature sensor 111 included in the sensor to by using the following expression (12).

core temperature Tc=Ts+α×Hs (12)

Here, a represents a proportionality coefficient, which is a value obtained in advance by using the temperature of an eardrum, the rectal, or the like.

The computation circuit 100 may generate and output time series data of estimated core body temperatures Tc of the living body B. The time series data means data including measurement time and estimated core body temperatures Tc associated with each other.

The memory tot stores information on a one-dimensional heat transfer model of a living body based on the foregoing expression (12). The memory 101 can be a specified storage area of a rewritable nonvolatile storage device (for example, a flash memory or the like) provided in the measurement system.

The communication circuit 102 outputs time series data of the core body temperature Tc of the living body B generated by the computation circuit 100, to the outside. In the case of outputting data in a wired way, the communication circuit 102 as above is an output circuit to which a USB cable or other types of cables can be connected, but it may be a wireless communication circuit, for example, conforming to Bluetooth (registered trademark), Bluetooth Low Energy, or the like.

The sheet-shaped base 14 not only functions as a base on which the measurement device 1A is placed including the sensor 10, the computation circuit 100, the memory 101, the communication circuit 102, and the battery 103 but also includes not-illustrated wiring for electrically connecting these elements. Considering that the measurement device 1 is connected to epidermis of a living body, it is desirable that a deformable flexible substrate be used for the sheet-shaped base 14.

Part of the sheet-shaped base 14 has an opening, and the heat flux sensor 110 and the temperature sensor 111 included in the sensor 10 are placed on the base 14 so as to be in contact with the measurement surface of the skin SK of the living body B through the opening.

Here, the measurement device 1A is configured by including a computer. Specifically, the computation circuit 100 is implemented, for example, by a processor such as a CPU or a DSP executing various kinds of data processing according to programs stored in the storage device such as a ROM, a RAM, or a flash memory, including the memory 101 provided in the measurement device 1A. The above programs for causing the computer to function as the measurement device 1 can be recorded on a recording medium or can be supplied through a network.

[Advantageous Effect of Measurement Device]

FIG. 6 shows measurement results of core body temperatures measured by using the measurement device 1A according to the present embodiment. In FIG. 6, the horizontal axis represents time [hours:minutes], and the vertical axis represents the core body temperature [° C.]. During the period from time [1:00] to [2:00] in FIG. 6, a fan set outside the measurement device 1A was on so that air flow came in contact with the measurement device 1A. In addition, during the period from time [3:00] to [3:30] in FIG. 6, the fan was on again so that air flow came in contact with the measurement device 1A.

In FIG. 6, the “estimation value” indicates values of the core body temperature measured by the measurement device 1A, and the “true value” indicates true values of the core body temperature for comparison. From FIG. 6, it can be seen that the values of the core body temperature estimated by the measurement device 1A agree with the true values of the core body temperature, and that thus it is possible to measure the core body temperature without being affected by the influence of change in convection.

As has been described above, in the measurement device 1A according to the second embodiment, the heat flux sensor 110 and the temperature sensor 111 are placed inside the first cover 12 having a hollow structure, and in addition, the second cover 13 is provided outside the first cover 12. The height L of the second cover 13 from the measurement surface is such that the Biot number Bi is approximately 0.1 or less. Thus, even if air flow comes in contact with the measurement device 1A, it is possible to reduce the influence of change in the heat resistance between the sensor 10 and outside air. This makes it possible to reduce the influence of change in convection and measure the core body temperature Tc of the living body B noninvasively.

Note that the described embodiments illustrate, as examples, cases in which the two hollow structures formed by the first cover 12 and the second cover 13 provide two air layers. However, if boundary layers are formed in which the influence of change in convection can be reduced, the number of air layers, in other words, the number of covers may be two or more. For example, the measurement device may further include, between the first cover 12 and the second cover 13, a third cover having a hollow structure and configured to be placed on the measurement surface so as to cover the first cover 12.

In addition, although the described embodiments illustrate, as examples, cases in which the first cover 12 and the second cover 13 have hollow structures having cylindrical outer shapes, the outer shapes of the first cover 12 and the second cover 13 may be not only cylindrical ones but also, for example, rectangular parallelepipeds or the like having hollow structures.

Although the embodiments of the measurement device of the present invention have been described above, the present invention is not limited to the described embodiments, but various modifications that those skilled in the art conceive can be made within the scope of the invention described in the claims.

### REFERENCE SIGNS LIST

1 Measurement Device
10 Sensor
11a, 11b Temperature Sensor
12 First Cover
13 Second Cover
14 Base
100 Computation Circuit
101 Memory
102 Communication Circuit
103 Battery.

1-7. (canceled)

8. A measurement device comprising:
a measurement device including a first temperature sensor configured to measure a temperature of a measurement surface;
a first cover having a hollow structure and covering the measurement device; and
a second cover having a hollow structure and covering the first cover to define an air layer between the first cover and the second cover.

9. The measurement device according to claim 8, wherein a Biot number that indicates stability of heat transfer from the measurement surface is 0.1 or less.

10. The measurement device according to claim 8, wherein:
the measurement device further includes a second temperature sensor; and
the first temperature sensor and the second temperature sensor are placed in an internal space of the first cover so as to face each other.

11. The measurement device according to claim 10, wherein a difference between a height of the first cover and a height of the second cover from the measurement surface as a reference is smaller than the height of the second cover from the measurement surface.

12. The measurement device according to claim 8, wherein the measurement device further includes a heat flux sensor.

13. The measurement device according to claim 8, further comprising:
a third cover having a hollow structure, the third cover being placed between the first cover and the second cover, and the third cover covering the first cover.

14. A measurement device comprising:
a measurement device including a first temperature sensor configured to measure a temperature of a measurement surface;
a first cover having a hollow structure and covering the measurement device;
a second cover having a hollow structure and covering the first cover to define an air layer between the first cover and the second cover;
a memory configured to store a one-dimensional model of heat transfer of a living body; and
a computation circuit configured to estimate a core temperature of the living body using a measurement value including temperature measured by the measurement device, based on the one-dimensional model stored in the memory.

15. A measurement device according to claim 14, wherein a Biot number that indicates stability of heat transfer from the measurement surface is 0.1 or less.

16. The measurement device according to claim 14, wherein:
the measurement device further includes a second temperature sensor; and
the first temperature sensor and the second temperature sensor are placed in an internal space of the first cover so as to face each other.

17. The measurement device according to claim 16, wherein a difference between a height of the first cover and a height of the second cover from the measurement surface as a reference is smaller than the height of the second cover from the measurement surface.

18. The measurement device according to claim 14, wherein the measurement device further includes a heat flux sensor.

19. The measurement device according to claim 14, further comprising:
a third cover having a hollow structure, the third cover being placed between the first cover and the second cover, and the third cover covering the first cover.
